(19) United States
(12) Patent Application Publication
(10) Pub. No.: US 2026/0032127 A1
(43) Pub. Date: Jan. 29, 2026

(54) Multi-Factor Verification in Machine-to-Machine Data Exchange

(71) Applicant: Bank of America Corporation, Charlotte, NC (US)

(72) Inventors: George Albero, Charlotte, NC (US); Naga Vamsi Krishna Akkapeddi, Charlotte, NC (US); Saurabh Arora, New Palam Vihar (IN)

(21) Appl. No.: 18/785,731

(22) Filed: Jul. 26, 2024

(51) Int. Cl. H04L 9/40

(52) U.S. Cl. CPC H04L 63/12; H04L 63/06; H04L 2463/082

(57) ABSTRACT

Arrangements for providing machine-to-machine multi-factor verification are provided. In some examples, a computing platform may detect via one or more quantum sensors, a first communication interaction between a first computing device and a second computing device. The computing platform may generate, for the first interaction, a hash of the first interaction. The hash may then be stored by the computing platform. The computing platform may detect, via the quantum sensors and at a subsequent time, a second communication interaction between the first computing device and the second computing device. The computing platform may generate a hash of the second interaction and may compare the hash of the first interaction to the hash of the second interaction. If the hashes do not match, the computing platform may pause communication between the first computing device and the second computing device and may execute one or more machine-to-machine multi-factor verification processes.

### BACKGROUND

Aspects of the disclosure relate to electrical computers, systems, and devices for multi-factor verification in machine-to-machine data exchange.

Enterprise organizations process thousands or maybe even millions of events or transactions each day that include communications between various computing devices. These communications between various computing devices often occur using specific communication methods and specific communication protocols for each computing device pair. Accordingly, an interruption in an expected pattern of communication in a computing device pair (e.g., a different communication method or protocol than an expected communication method or protocol) may occur due to interruptions in network access or attempted access by an unauthorized user. These interruptions in expected patterns may result in undesirable results. Accordingly, aspects described herein provide for multi-factor verification or validation in machine-to-machine data exchange or communication in order to ensure communication security and integrity.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with validating machine-to-machine communications.

In some aspects, a computing platform may detect, via one or more quantum sensors, a pattern of communication between a first computing device of a plurality of computing devices, and a second computing device of the plurality of computing devices. In some examples, the pattern of communication may include a communication method and a communication protocol used for communication for each communication interaction between the first computing device and the second computing device.

The computing platform may detect, via the one or more quantum sensors, a first communication interaction between the first computing device and the second computing device. The computing platform may generate, for the first communication interaction, a hash of the first communication interaction. In some examples, the hash may be based on the communication method and communication protocol used for communication between the first computing device and the second computing device in the first communication interaction. The hash may then be stored by the computing platform.

In some examples, the computing platform may detect, via the one or more quantum sensors and at a subsequent time, a second communication interaction between the first computing device and the second computing device. The computing platform may generate a hash of the second communication interaction based on the communication method and communication protocol used in the second communication interaction.

The computing platform may compare the hash of the first communication interaction to the hash of the second communication interaction and, if the hashes match, the hash of the second communication interaction may be stored as a new version. If the hashes do not match, the computing platform may pause communication between the first computing device and the second computing device and may execute one or more machine-to-machine multi-factor verification processes.

In some examples, executing the one or more machine-to-machine multi-factor verification processes may include generating a false fingerprint and sending the false fingerprint to the first computing device. If the first computing device attempts communication based on the false fingerprint, the first computing device may be compromised and the communication between the first computing device and at least the second computing device may be blocked.

In some arrangements, executing the one or more machine-to-machine multi-factor verification processes may include generating a test message using a communication protocol identified for the first computing device and the second computing device. The test message may be transmitted to the first computing device using the identified protocol. If the first computing device does not confirm receipt of the test message, the first computing device may be compromised and the communication between the first computing device and at least the second computing device may be blocked.

In still other arrangements, executing the one or more machine-to-machine multi-factor verification processes may include generating a quantum encrypted key and an instruction causing the quantum encrypted key to be transmitted to the first computing device using a random communication protocol. The instruction and key may be transmitted to the first computing device. If a response including the key is detected from a device other than the first computing device, the first computing device may be compromised and the communication between the first computing device and at least the second computing device may be blocked.

In other examples, executing the one or more machine-to-machine multi-factor verification processes may include generating a communication and instruction that may cause the second computing device to request a third device to communicate with the first computing device using an initially agreed communication protocol between the first computing device and the second computing device. The computing platform may send the communication and instruction to the second computing device which may cause the second computing device to send the instruction to initiate communication to the third computing device. If communication between the first computing device and the third computing device is successful, the first computing device may be compromised and communication between the first computing device and at least the second computing device may be blocked.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing machine-to-machine multi-factor validation in accordance with one or more aspects described herein;

FIGS. 2A-2G depict an illustrative event sequence for machine-to-machine multi-factor validation in accordance with one or more aspects described herein;

FIG. 3 illustrates an illustrative method for machine-to-machine multi-factor validation according to one or more aspects described herein;

FIGS. 4-7 illustrate example method of multi-factor validation according to one or more aspects described herein; and

FIG. 8 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, enterprise organizations may process millions of events or transactions each day. Each of these transactions may involve machine-to-machine data exchange or communication and, in some examples, multiple different machines communicating with other machines in system. Accordingly, it may be advantageous to verify or validate the machine-to-machine communication using multi-factor verification.

Accordingly, aspects described herein provide for establishing patterns of communication between computing device pairs. For instance, each pair of computing devices in a system having a plurality of computing devices may communicate using a particular communication method and a particular communication protocol. A hash or token may be generated for each interaction between a computing device pair that includes device identifiers, communication method, communication protocol, and the like, and may be stored. Upon subsequent communication, a hash or token may be generated and compared to a previously stored hash or token associated with a prior communication between the computing device pair. If a match does not occur, an issue may be detected and multi-factor verification processes may be initiated.

These and various other arrangements will be discussed more fully below.

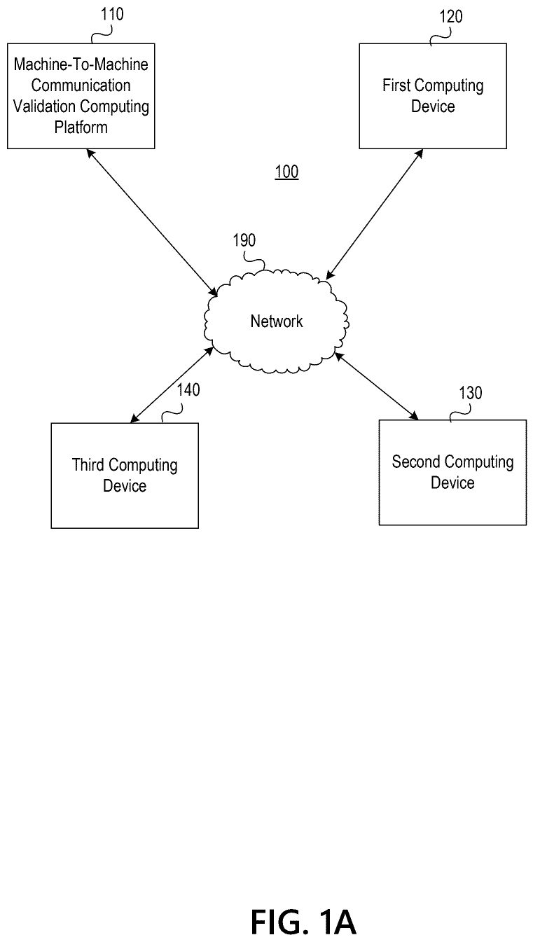

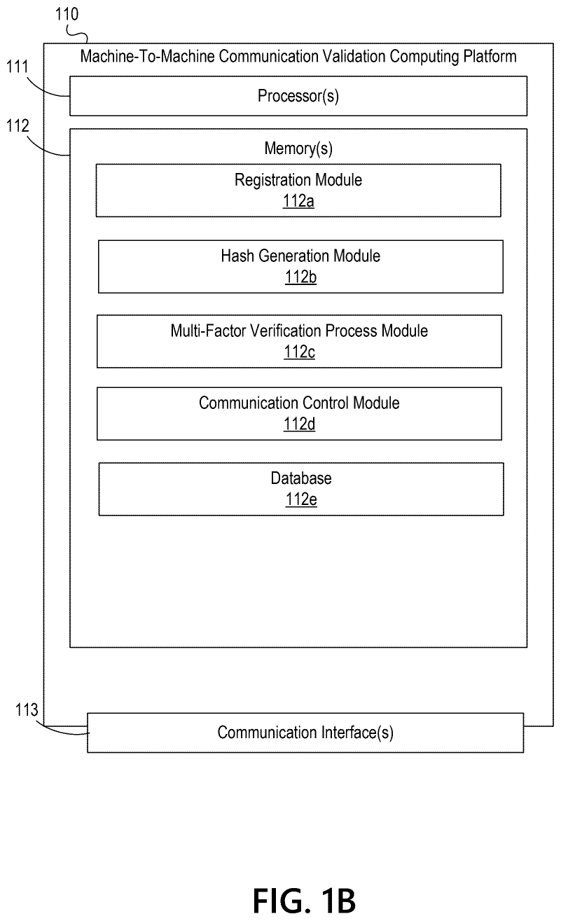

FIGS. 1A-1B depict an illustrative computing environment and devices for implementing multi-factor machine-to-machine validation functions in accordance with one or more aspects described herein. Referring to FIG. 1A, computing environment 100 may include one or more computing devices and/or other computing systems. For example, computing environment 100 may include machine-to-machine communication validation computing platform 110, first computing device 120, second computing device 130, and third computing device 140.

Although three computing devices are shown, any number of systems or devices may be used without departing from the invention.

Machine-to-machine communication validation computing platform 110 may be configured to perform intelligent, dynamic, real-time machine-to-machine data exchange validation. For instance, machine-to-machine communication validation computing platform 110 may establish, based on quantum sensors, an expected pattern of communication between pairs of computing devices in a system including a plurality of computing devices. For instance, each computing device pair may have an expected communication method and an expected communication protocol. For each interaction between a computing device pair, machine-to-machine communication validation computing platform 110 may generate a hash or token including the communication method, communication protocol, one or more device identifiers, and the like. The hash or token may be stored. In some examples, each hash or token generated for a computing device pair interaction may be stored as a new version of a previous hash or token associated with a prior interaction.

As a subsequent communication between the computing device pair occurs, machine-to-machine communication validation computing platform 110 may generate a hash or token and may compare the generated hash or token to the previously stored hash or token. If the tokens match, no issue is detected and communication may proceed. If the tokens do not match (e.g., a different communication method or protocol is used), a potential issue may be detected and communication between the first computing device and the second computing device in the computing device pair may be paused while further investigation is performed. In some examples, the ongoing communication may be transferred to a secure operating environment (e.g., sandbox) for further evaluation. Further, detection of a potential issue may trigger multi-factor verification processes.

For instance, if a potential issue is detected, machine-to-machine communication validation computing platform 110 may execute one or more multi-factor verification processes. For instance, in some examples, a false machine fingerprint may be used to determine whether the potential issue is an actual issue or if communication may continue. That is, each computing device may have a particular fingerprint that includes user profile details, location of the device, usage patterns, communication methods (e.g., Bluetooth, Bluetooth Low Energy, radio frequency identification (RFID), near-field communication, secure machine-to-machine (M2M) communication, and the like), communication protocols (e.g., message queuing telemetry transport (MQTT), constrained application protocol (CoAP), OPC unified architecture (OPC UA), secure RADIUS, and the like) and the like. In some examples, if a potential issue is detected, machine-to-machine communication validation computing platform 110 may generate a false fingerprint representing the second computing device and transmit the false fingerprint to the first computing device. If the first computing device attempts communication based on the false fingerprint, an issue may be detected and communication between the first computing device and at least the second computing device may be blocked or prevented.

In another example, machine-to-machine communication validation computing platform 110 may generate a test message and may transmit the test message to the first computing device using an initially agreed communication protocol. In some examples, the test message may include a request for confirmation. In some examples, an automatically generated acknowledgement that the test message was delivered may be received. However, if the first computing device generates and sends a confirmation message, the initially agreed communication protocol is working and communication may continue. If no confirmation is received, an issue may be detected and communication between the first computing device and at least the second computing device may be blocked or prevented.

In yet another example, machine-to-machine communication validation computing platform 110 may send a communication to the first computing device using a random communication protocol (e.g., not an expected communication protocol but a randomly identified protocol). The communication may include a quantum encrypted key attached to the message. If a response including the key is received from the first computing device, the first computing device may be validated and the communication may continue. If the response including the key is received from a third computing device, it may indicate that the first computing device was not able to use the suggested protocol and therefore has been compromised. Accordingly, communication from the first computing device to at least the second computing device may be blocked or prevented.

In still another example, machine-to-machine communication validation computing platform 110 may cause a test message to be transmitted by a third computing device to the first computing device using an initially agreed communication protocol (e.g., using the third computing device as bait). If the third computing device is able to communicate with the first computing device via the initially agreed communication protocol, an indication may be transmitted to the second computing device that the first computing device is compromised and communication between the first computing device and at least the second computing device may be blocked.

Various other arrangements may be used without departing from the invention.

First computing device 120, second computing device 130 and/or third computing device 140 may be or include one or more computer components (e.g., servers, server blades, memory, processors, or the like) and may each include systems, applications, and the like, for processing events or transactions. Accordingly, first computing device 120, second computing device 130, and/or third computing device 140 may be a plurality of computing devices in a system for processing transactions or events and may communicate with each other via machine-to-machine communication or data exchange in order to process transactions.

As mentioned above, computing environment 100 also may include one or more networks, which may interconnect one or more of machine-to-machine communication validation computing platform 110, first computing device 120, second computing device 130, and/or third computing device 140. For example, computing environment 100 may include network 190, which may be a public or private network. Network 190 may include one or more sub-networks (e.g., Local Area Networks (LANs), Wide Area Networks (WANs), or the like). Network 190 may interconnect one or more computing devices associated with the organization. For example, machine-to-machine communication validation computing platform 110, first computing device 120, second computing device 130, and/or third computing device 140 may be connected via network 190.

Referring to FIG. 1B, machine-to-machine communication validation computing platform 110 may include one or more processors 111, memory 112, and communication interface 113. A data bus may interconnect processor(s) 111, memory 112, and communication interface 113. Communication interface 113 may be a network interface configured to support communication between machine-to-machine communication validation computing platform 110 and one or more networks (e.g., network 190, or the like). Memory 112 may include one or more program modules having instructions that when executed by processor(s) 111 cause machine-to-machine communication validation computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of machine-to-machine communication validation computing platform 110 and/or by different computing devices that may form and/or otherwise make up machine-to-machine communication validation computing platform 110.

For example, memory 112 may have, store and/or include registration module 112a. registration module 112a may store instructions and/or data that may cause or enable the machine-to-machine communication validation computing platform 110 to receive data registering one or more systems, devices, and the like, such as first computing device 120, second computing device 130 and/or third computing device 140. The registration module 112a may receive data identifying the devices, communication methods and protocols for different device pairs, and the like.

Machine-to-machine communication validation computing platform 110 may further have, store and/or include hash generation module 112b. Hash generation module 112b may store instructions and/or data that may cause or enable the machine-to-machine communication validation computing platform 110 to generate a hash or token associated with each communication between device pairs. For instance, for each interaction between a device pair (e.g., first computing device 120 and third computing device 140, second computing device 130 and third computing device 140, or the like) a hash or token may be generated based on the devices in the device pair, communication method being used, communication protocol being used, and the like. The hashes or tokens may be stored (e.g., in database 112e) as versions and may be compared to subsequently generated hashes or tokens to identify potential issues or compromised devices.

Machine-to-machine communication validation computing platform 110 may further have, store and/or include multi-factor verification process module 112c. Multi-factor verification process module 112c may store instructions and/or data that may cause or enable the machine-to-machine communication validation computing platform 110 to execute one or more multi-factor verification processes as discussed herein. For instance, multi-factor verification process module 112c may generate a false fingerprint to transmit to a device to determine if the device is compromised. In another example, multi-factor verification process module may generate and send or cause a device to send a test message to a device and, if confirmation of receipt is not received, may determine that the machine or device is compromised. In still another example, multi-factor verification process module 112c may generate an encrypted key and send the key with a communication to a device to determine if the device is compromised. In yet another example, multi-factor verification process module 112c may communicate or cause a device to communicate with a third device to determine whether another device is compromised.

Machine-to-machine communication validation computing platform 110 may further have, store and/or include communication control module 112d. Communication control module 112d may store instructions and/or data that may cause or enable the machine-to-machine communication validation computing platform 110 to prevent communication between two or more devices upon detecting a potential issue, upon determining that the potential issue is an issue, or the like. In some examples, communication control module 112d may transfer communications to a secure operating environment (e.g., sandbox) for execution of the multi-factor verification processes described herein. Further, while aspects are described as initiating or executing multi-factor verification processes in response to a suspected issue (e.g., suspected compromised machine) in some examples, communication control module 112d may cause execution of one or more multi-factor verification processes proactively to test communication between machines or devices (e.g., without a suspected issue). In those examples, the timing of the multi-factor verification process, type of multi-factor verification process, and the like may be randomly identified or generated.

Machine-to-machine communication validation computing platform 110 may further include database 112e. Database 112e may store data related to registered devices, hashes generated, and/or other data to perform the functions of the machine-to-machine communication validation computing platform 110.

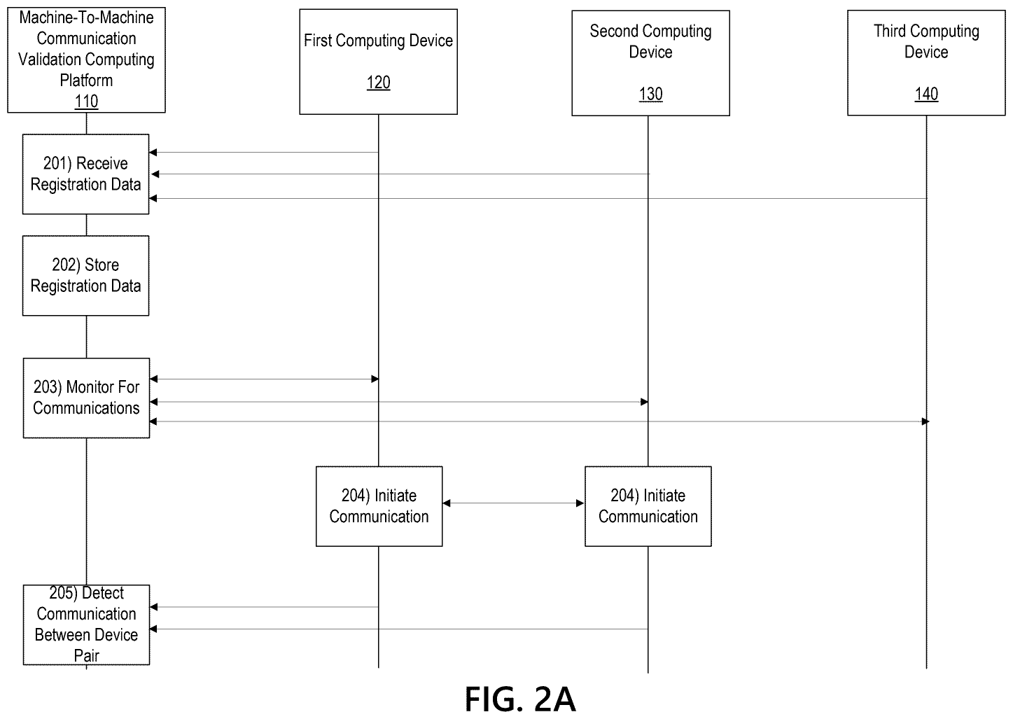

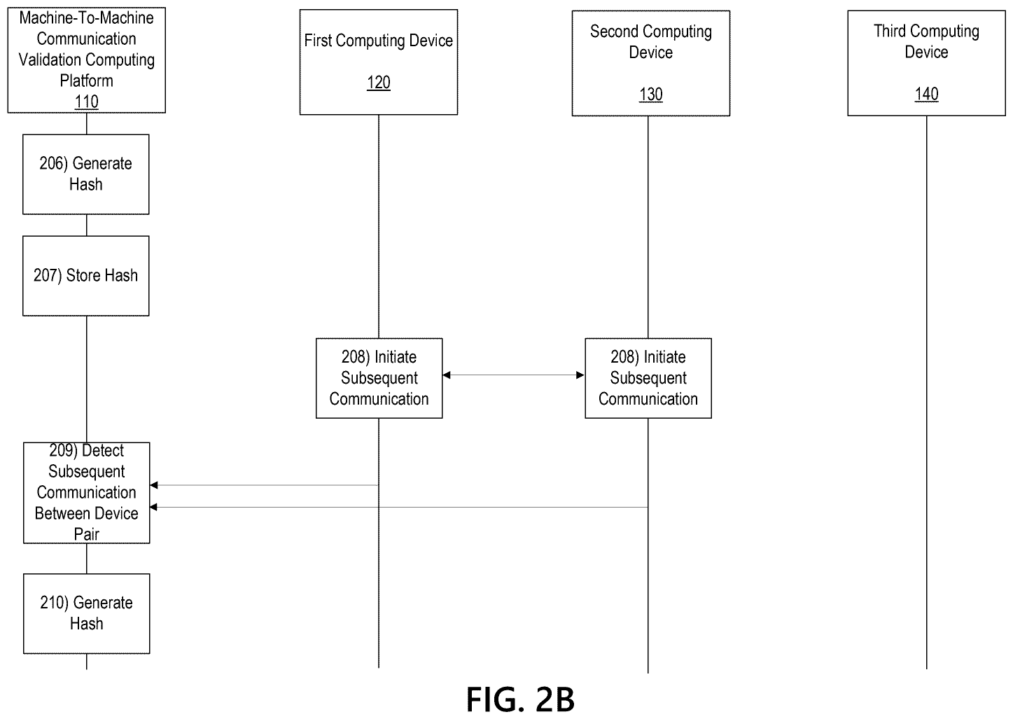

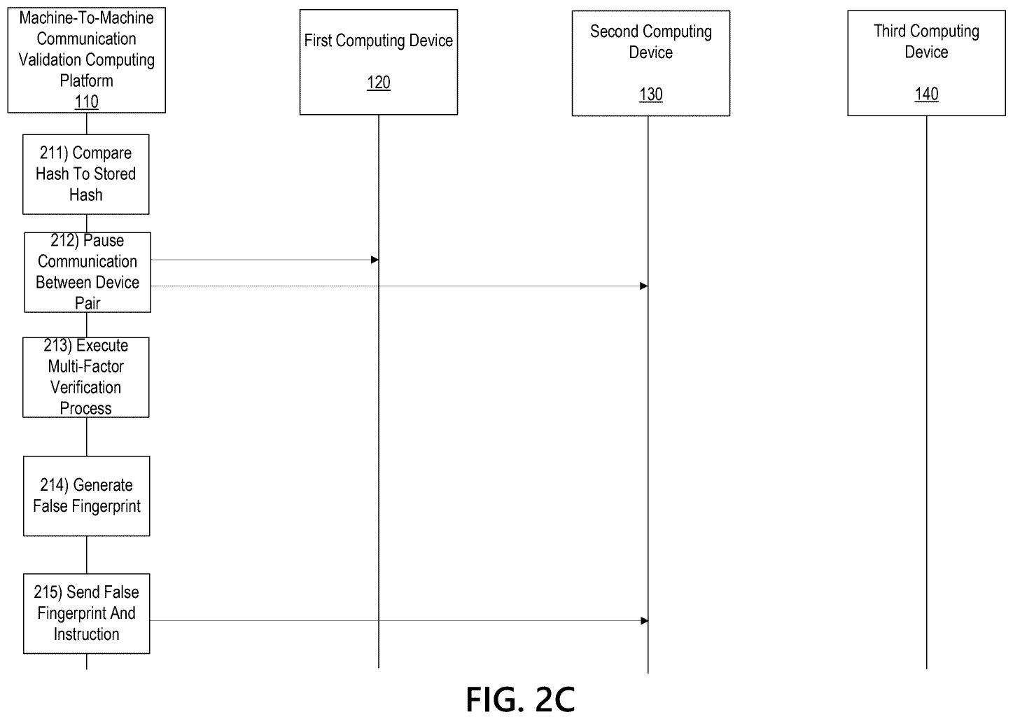

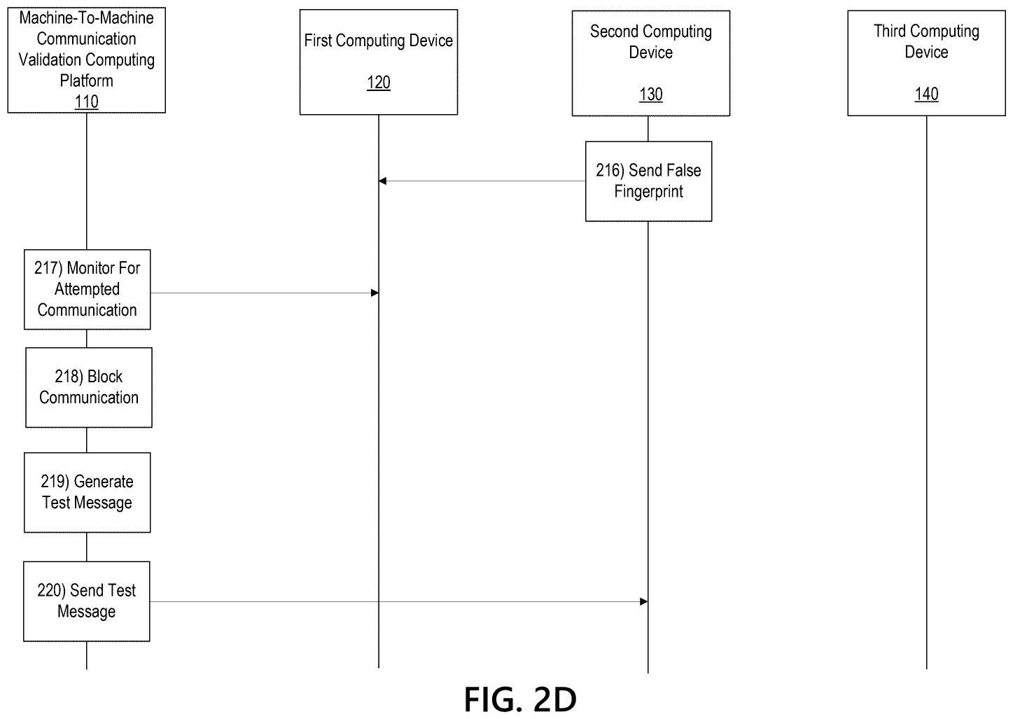

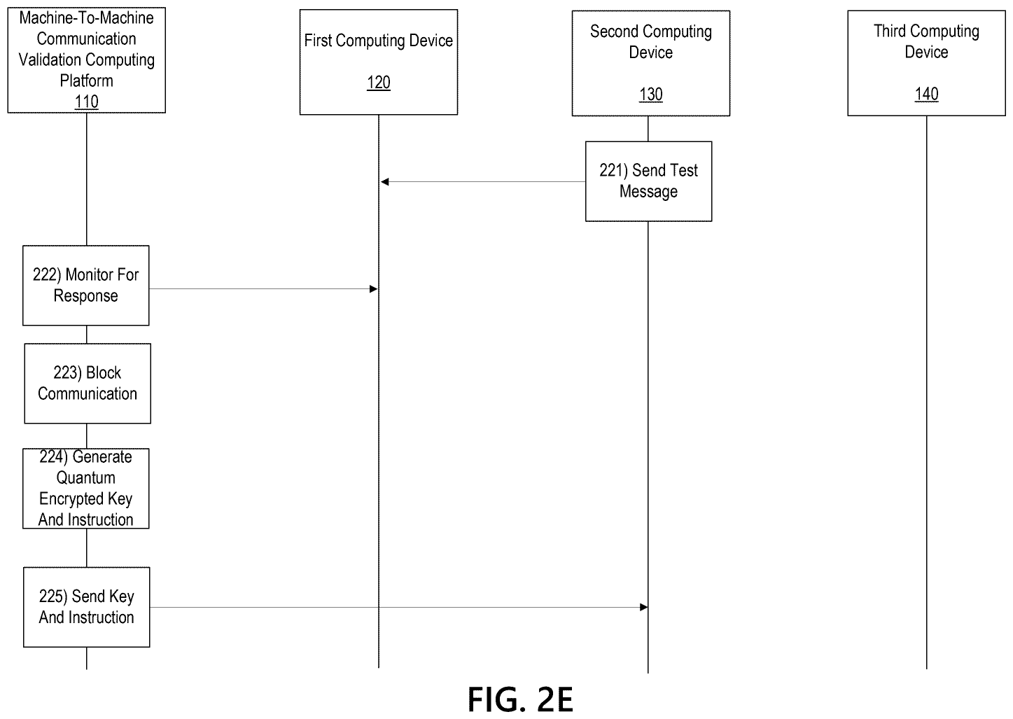

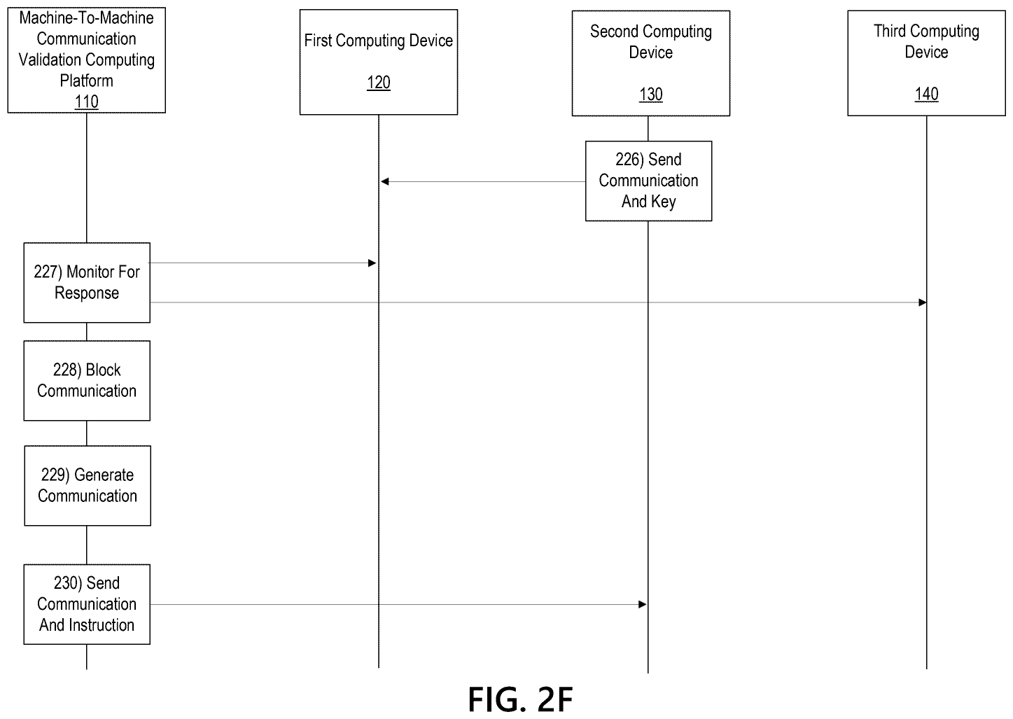

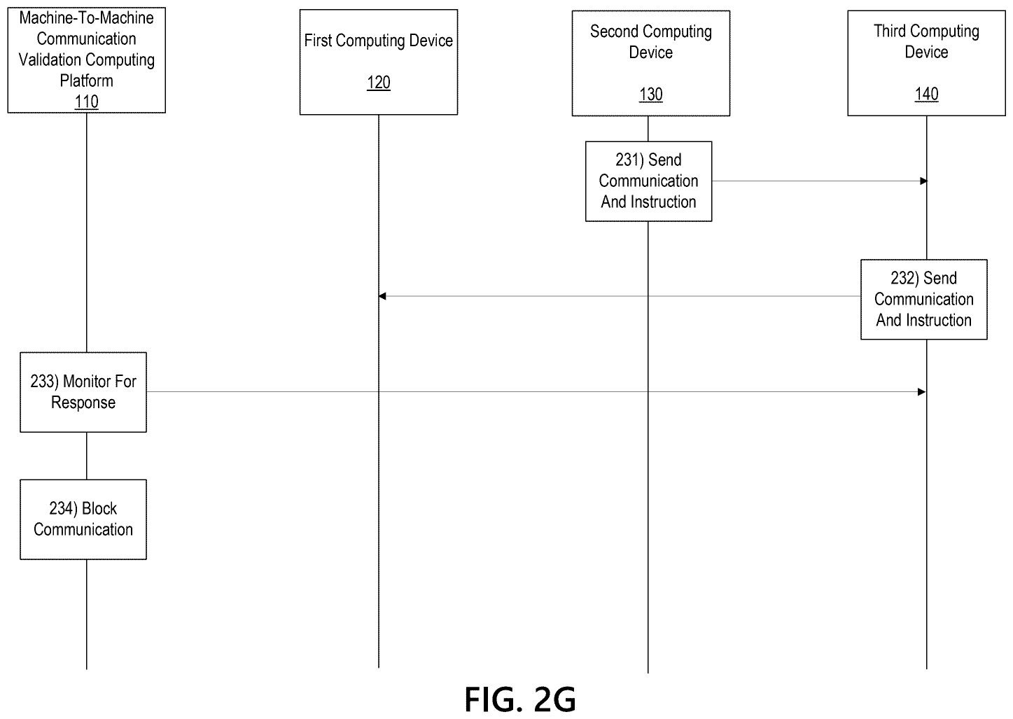

FIGS. 2A-2G depict one example illustrative event sequence for machine-to-machine communication validation in accordance with one or more aspects described herein. The events shown in the illustrative event sequence are merely one example sequence and additional events may be added, or events may be omitted, without departing from the invention. Further, one or more processes discussed with respect to FIGS. 2A-2G may be performed in real-time or near real-time.

With reference to FIG. 2A, at step 201, machine-to-machine communication validation computing platform 110 may receive registration data from a plurality of computing devices in a computing system or environment. For instance, one or more computing devices that may communicate with each other may register for machine-to-machine communication validation. In some examples, the registration data may include identification of each computing device, a communication method and protocol used in each device pair, and the like.

At step 202, machine-to-machine communication validation computing platform 110 may store the registration data (e.g., in database 112e).

At step 203, machine-to-machine communication validation computing platform 110 may monitor the registered devices for communications between computing devices. For instance, machine-to-machine communication validation computing platform 110 may monitor each registered device to detect a communication with one or more other devices in a device pair interaction. For instance, quantum sensors may be used to detect and establish communication methods and protocols used in a communication interaction between a device pair.

At step 204, a device pair may initiate communication. For instance, first computing device 120 and second computing device 130 may initiate communication. In some examples, the communication may be initiated during the course of business (e.g., in sharing data to process transactions, or the like).

At step 205, machine-to-machine communication validation computing platform 110 may detect, based on the monitoring, the communication interaction between first computing device 120 and second computing device 130 initiated at step 204.

With reference to FIG. 2B, at step 206, machine-to-machine communication validation computing platform 110 may generate a hash or token for the communication interaction between first computing device 120 and second computing device 130. For instance, machine-to-machine communication validation computing platform 110 may generate a hash or token based on identifiers of each device, a communication method used in the communication interaction, a communication protocol used in the communication interaction, and the like.

At step 207, machine-to-machine communication validation computing platform 110 may store the hash (e.g., at database 112e).

At step 208, first computing device 120 and second computing device 130 may initiate a subsequent communication interaction (e.g., a communication occurring at a later time or after the communication interaction initiated at step 204.

At step 209, machine-to-machine communication validation computing platform 110 may detect the subsequent communication interaction between the first computing device 120 and the second computing device 130.

At step 210, machine-to-machine communication validation computing platform 110 may generate a hash or token for the subsequent communication interaction between first computing device 120 and second computing device 130. For instance, machine-to-machine communication validation computing platform 110 may generate a hash or token based on identifiers of each device, a communication method used in the subsequent communication interaction, a communication protocol used in the subsequent communication interaction, and the like.

With reference to FIG. 2C, at step 211, machine-to-machine communication validation computing platform 110 may compare the hash generated for the subsequent communication interaction to the stored hash (or a most recently stored hash, or the like). If there is a match, the process may store the hash generated for the subsequent communication interaction as a new version of the hash (e.g., in database 112e) and may continue to monitor for additional communication interactions.

If, at step 211, the hash for the subsequent communication interaction does not match the stored hash, a potential issue may be identified (e.g., a machine or computing device may be compromised). Accordingly, at step 212, machine-to-machine communication validation computing platform 110 may pause communication between the first computing device 120 and the second computing device 130 (e.g., while further investigation is performed). In some examples, pausing communication may include transferring the communication to a secure operating environment or sandbox to perform additional analysis.

At step 213, machine-to-machine communication validation computing platform 110 may execute one or more multi-factor verification processes. For instance, one or more of the multi-factor verification processes described above and described herein with respect to steps 214-234 may be executed.

For instance, in one arrangement, a false fingerprint may be used to determine whether one or more computing devices are compromised. Accordingly, at step 214, machine-to-machine communication validation computing platform 110 may generate a false fingerprint. As discussed herein, each device may have a “fingerprint” generated based on user profile details, location of the device, usage patterns, communication method, communication protocol, and the like. machine-to-machine communication validation computing platform 110 may generate the false fingerprint and, at step 215, may transmit or send the false fingerprint to a computing device in the device pair that is not suspected of being compromised. In this example, second computing device 130 may be considered secure while first computing device 120 may be considered potentially compromised. Accordingly, machine-to-machine communication validation computing platform 110 may transmit or send the false fingerprint to the second computing device 130 with an instruction that may cause the second computing device 130 to transmit the false fingerprint to the first computing device 120.

With reference to FIG. 2D, at step 216, the second computing device 130 may transmit or send the false fingerprint to the first computing device 120.

At step 217, machine-to-machine communication validation computing platform 110 may monitor activity at the first computing device 120 to determine whether the first computing device 120 begins using the false fingerprint (e.g., the first computing device 120 does not recognize the fingerprint sent by the second computing device 130 as a false fingerprint of the second computing device 130 rather than the actual fingerprint and may begin or attempt to use the false fingerprint). If machine-to-machine communication validation computing platform 110 does not detect attempted use of the false fingerprint by the first computing device 120, the first computing device 120 might not be compromised and communication may continue between the device pair.

Alternatively, if machine-to-machine communication validation computing platform 110 detects that first computing device 120 attempts to use the false fingerprint, that may indicate that the first computing device 120 is compromised and, accordingly, communication between the first computing device 120 and the second computing device 130 may be terminated and/or blocked at step 218. In some examples, communication between the first computing device 120 and all computing devices in the system may be blocked.

In another example multi-factor verification process, at step 219, machine-to-machine communication validation computing platform 110 may generate a test message to be sent by second computing device 130 (the uncompromised device) to the first computing device 120 (the potentially compromised device) using an initially agreed communication protocol and requesting that the first computing device 120 acknowledge receipt of the message.

At step 220, machine-to-machine communication validation computing platform 110 may transmit or send the test message to the second computing device 130 with an instruction or command causing the second computing device 130 to send the test message via the initially agreed protocol to the first computing device 120.

With reference to FIG. 2E, at step 221, second computing device 130 may transmit or send the test message to the first computing device 120 using the initially agreed communication protocol (e.g., by executing the instruction received from the machine-to-machine communication validation computing platform 110). The second computing device 130 may receive an automatic acknowledgement that the test message was received by the first computing device 120 (e.g., thereby confirming delivery).

At step 222, machine-to-machine communication validation computing platform 110 may monitor the first computing device 120 for a confirmation that the test message was received. If the first computing device confirms receipt of the test message, the first computing device is likely not compromised and communication may continue between the device pair.

Alternatively, if the first computing device 120 does not confirm receipt of the test message, the first computing device 120 may be compromised and accordingly, communication between the first computing device 120 and the second computing device 130 may be terminated and/or blocked at step 223. In some examples, communication between the first computing device 120 and all computing devices in the system may be blocked.

In yet another multi-factor verification process, machine-to-machine communication validation computing platform 110 may generate a quantum encrypted key and an instruction that may cause the second computing device 130 (the uncompromised device) to transmit or send the encrypted quantum key to the first computing device 120 (the potentially compromised device) using a random protocol at step 224.

At step 225, machine-to-machine communication validation computing platform 110 may transmit or send the instruction and the quantum encrypted key to the second computing device 130 to execute the instruction.

With reference to FIG. 2F, at step 226, second computing device 130 may execute the instruction and send a communication including the quantum encrypted key to the first computing device 120 using the random protocol. If the device is compromised, it might not be able to use the suggested random protocol and, instead, may enlist another device (e.g., third computing device 140) to transmit a response.

Accordingly, at step 227, machine-to-machine communication validation computing platform 110 may monitor one or more devices for a response to the communication. For instance, the machine-to-machine communication validation computing platform 110 may monitor the first computing device 120 and one or more other devices in the system, such as third computing device 140. In some examples, machine-to-machine communication validation computing platform 110 may monitor all devices in the system.

If, based on the monitoring, machine-to-machine communication validation computing platform 110 detects that a response including the quantum encrypted key is coming from the first computing device 120, the first computing device 120 might not be compromised and communication may continue.

Alternatively, if machine-to-machine communication validation computing platform 110 detects that a response including the quantum encrypted key (e.g., shared by the first computing device 120) is coming from another device, such as third computing device 140, the first computing device 120 may be considered compromised and, accordingly, communication between the first computing device 120 and the second computing device 130 may be terminated and/or blocked at step 228. In some examples, communication between the first computing device 120 and all computing devices in the system may be blocked.

In still another example multi-factor verification process, machine-to-machine communication validation computing platform 110 may generate a communication and instruction that may cause the second computing device 130 to request the third computing device 140 to communicate with the first computing device 120 (the potentially compromised device) using an initially agreed protocol between first computing device 120 and second computing device 130 at step 229. The machine-to-machine communication validation computing platform 110 may essentially use the third computing device 140 as bait to attempt to engage the first computing device 120.

At step 230, machine-to-machine communication validation computing platform 110 may transmit or send the communication and instruction to the second computing device 130.

With reference to FIG. 2G, at step 231, the second computing device 130 may execute the instruction and may send the communication to the third computing device 140 with an instruction that may cause the third computing device 140 to communicate with the first computing device 120.

At step 232, the third computing device 140 may transmit or send the communication using the initially agreed protocol between first computing device 120 and second computing device 130.

At step 233, machine-to-machine communication validation computing platform 110 may monitor first computing device 120 to determine whether communication between the first computing device 120 and the third computing device 140 is successful (e.g., the first computing device 120 responded to the communication from the third computing device 140). If the first computing device 120 did not communicate with the third computing device 140, the first computing device 120 might not be compromised and communication between the first computing device 120 and the second computing device 130 may continue.

Alternatively, if the first computing device 120 did communicate with the third computing device 140, the first computing device 120 may be considered compromised and, accordingly, communication between the first computing device 120 and the second computing device 130 may be terminated and/or blocked at step 234. In some examples, communication between the first computing device 120 and all computing devices in the system may be blocked.

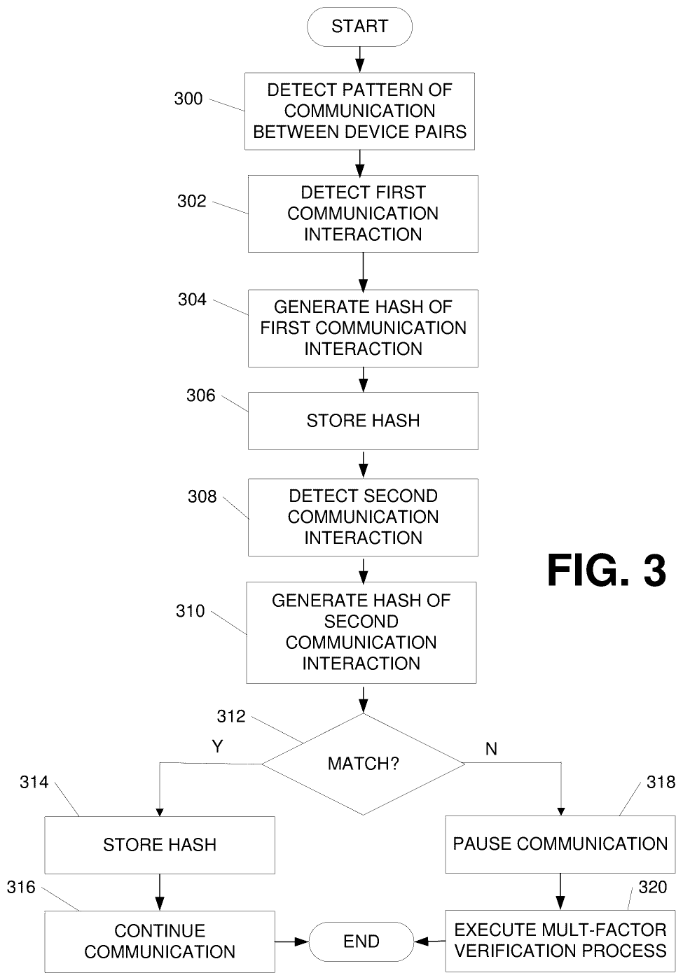

FIG. 3 is a flow chart illustrating one example method of machine-to-machine communication verification in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, machine-to-machine communication validation computing platform 110 may identify a pattern of communication between pairs of computing devices in a system. For instance, patterns of communication between a first computing device of a plurality of computing devices and a second computing device of the plurality of computing devices forming a computing device pair may be detected by one or more quantum sensors associated with each computing device. In some examples, the communication patterns may include a communication method and a communication protocol used by the computing device pair. In some examples, the communication method may be one of Bluetooth, Bluetooth Low Energy, radio frequency identification (RFID), near-field communication, or secure machine-to-machine (M2M) communication. In some examples, the communication protocol may be one of message queuing telemetry transport (MQTT), constrained application protocol (CoAP), OPC unified architecture (OPC UA), or secure RADIUS.

At step 302, machine-to-machine communication validation computing platform 110 may detect, via the one or more quantum sensors, a first communication interaction between a first computing device 120 and a second computing device 130.

At step 304, machine-to-machine communication validation computing platform 110 may generate a hash or token associated with the first communication interaction between the first computing device 120 and the second computing device 130. In some examples, the hash may be based on a communication method and a communication protocol used for communication between the first computing device 120 and the second computing device 130 in the first communication interaction. In some examples, the hash may be further based on an identifier associated with the first computing device 120 and an identifier associated with the second computing device 130.

At step 306, machine-to-machine communication validation computing platform 110 may store the generated hash or token.

At step 308, machine-to-machine communication validation computing platform 110 may detect, via the one or more quantum sensors, a second communication interaction between a first computing device 120 and a second computing device 130.

At step 310, machine-to-machine communication validation computing platform 110 may generate a hash or token associated with the second communication interaction between the first computing device 120 and the second computing device 130. In some examples, the hash may be based on a communication method and a communication protocol used for communication between the first computing device 120 and the second computing device 130 in the second communication interaction. In some examples, the hash may be further based on an identifier associated with the first computing device 120 and an identifier associated with the second computing device 130.

At step 312, machine-to-machine communication validation computing platform 110 may compare the hash generated for the second communication interaction to the stored hash for the first communication interaction to determine whether a match exists. If the hashes match, at step 314, machine-to-machine communication validation computing platform 110 may store the hash for the second communication interaction. In some examples, the hash may be stored as a new version. At step 316, communication between the first computing device 120 and the second computing device 130 may continue (e.g., no indication of compromise of a device).

If, at step 312, the hashes do not match, at step 318, machine-to-machine communication validation computing platform 110 may pause the communication between the first computing device 120 and the second computing device 130 (e.g., the second communication interaction). At step 320, machine-to-machine communication validation computing platform 110 may execute one or more machine-to-machine multi-factor verification processes as discussed herein.

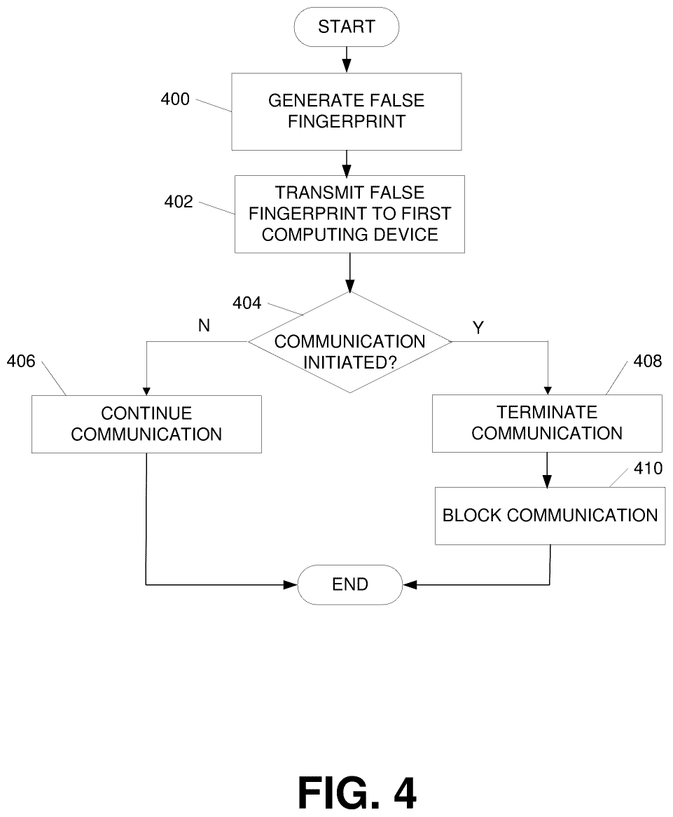

FIGS. 4-7 are flow charts illustrating example methods of machine-to-machine multi-factor verification processes in accordance with one or more aspects described herein. The processes illustrated in FIGS. 4-7 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIGS. 4-7 may be performed in real-time or near real-time.

With respect to FIG. 4, in response to execution of one or more machine-to-machine multi-factor verification processes at step 320, at step 400, machine-to-machine communication validation computing platform 110 may generate a false fingerprint.

At step 402, machine-to-machine communication validation computing platform 110 may transmit the false fingerprint to the first computing device 120 (e.g., the device that may be compromised). In some examples, transmitting the false fingerprint to the first computing device 120 may include transmitting the false fingerprint to the second computing device 130 (e.g., the uncompromised device in the device pair) with an instruction causing the second computing device 130 to send the false fingerprint to the first computing device 120.

At step 404, machine-to-machine communication validation computing platform 110 may monitor the first computing device to determine whether an indication is received that the first computing device 120 attempted to initiate or further communication with the second computing device 130 based on the false fingerprint.

If, at step 404, no indication of communication is received, the first computing device 120 might not be compromised and communication may continue between the first computing device 120 and the second computing device 130 at step 406 (e.g., the pause may be removed).

If, at step 404, an indication that communication is initiated is received or detected, the first computing device may be considered compromised and, at step 408, the paused communication between the first computing device 120 and the second computing device 130 may be terminated. At step 410, communication between the first computing device 120 and the second computing device 130 may be blocked. In some examples, blocking communication with the first computing device 120 may include blocking communication between the first computing device 120 and the plurality of computing devices (e.g., all computing devices in the system).

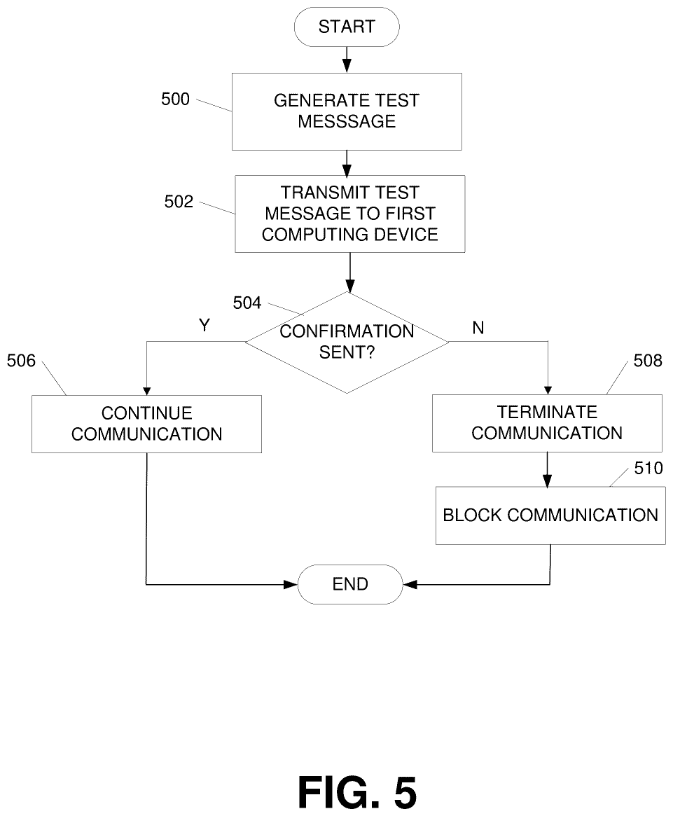

With reference to FIG. 5, another machine-to-machine multi-factor verification process may be executed (e.g., at step 320) and may include, at step 500, machine-to-machine communication validation computing platform 110 may generate a test message using a communication protocol initially agreed to or identified for the first computing device 120 and the second computing device 130.

At step 502, the test message may be transmitted to the first computing device 120 via the identified communication protocol. In some examples, transmitting the test message to the first computing device 120 may include generating an instruction causing the second computing device 130 to transmit the test message to the first computing device and transmitting the instruction to the second computing device for execution.

At step 504, machine-to-machine communication validation computing platform 110 may monitor the first computing device to determine whether a confirmation receipt of the test message is sent by the first computing device.

If, at step 504, a confirmation receipt is sent, the first computing device 120 might not be compromised and communication between the first computing device 120 and the second computing device 130 may continue at step 506 (e.g., the pause may be removed).

If, at step 504, no confirmation receipt is sent, at step 508, the first computing device 120 may be considered compromised and the paused communication between the first computing device 120 and the second computing device 130 may be terminated. At step 510, communication between the first computing device 120 and the second computing device 130 may be blocked. In some examples, blocking communication with the first computing device 120 may include blocking communication between the first computing device 120 and the plurality of computing devices (e.g., all computing devices in the system).

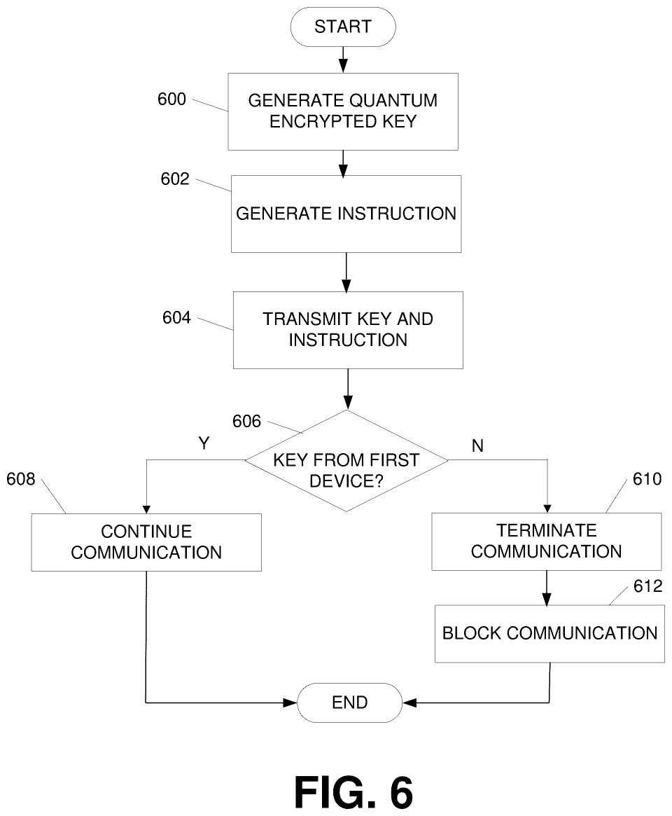

With reference to FIG. 6, yet machine-to-machine multi-factor verification process may be executed (e.g., at step 320) and may include, at step 600, machine-to-machine communication validation computing platform 110 may generate a quantum encrypted key.

At step 602, machine-to-machine communication validation computing platform 110 may generate an instruction causing the quantum encrypted key to be transmitted to the first computing device 120 using a random communication protocol.

At step 604, the machine-to-machine communication validation computing platform 110 may transmit or send the instruction and quantum encrypted key to the second computing device 130. In some examples, sending the quantum encrypted key and instruction causes the second computing device 130 to execute the instruction and send the quantum encrypted key to the first computing device 120 using the random protocol.

At step 606, machine-to-machine communication validation computing platform 110 may monitor the plurality of devices to detect a response including the quantum encrypted key. If the response including the key is detected from the first computing device 120, at step 608, the first computing device 120 might not be considered compromised and communication between the first computing device 120 and the second computing device 130 may continue (e.g., the pause may be removed).

If, at step 606, the response is detected from a device other than the first computing device 120 (e.g., response not detected from first computing device 120), the first computing device 120 may be considered compromised and the paused communication between the first computing device 120 and the second computing device 130 may be terminated at step 610. At step 612, communication between the first computing device 120 and the second computing device 130 may be blocked. In some examples, blocking communication with the first computing device 120 may include blocking communication between the first computing device 120 and the plurality of computing devices (e.g., all computing devices in the system).

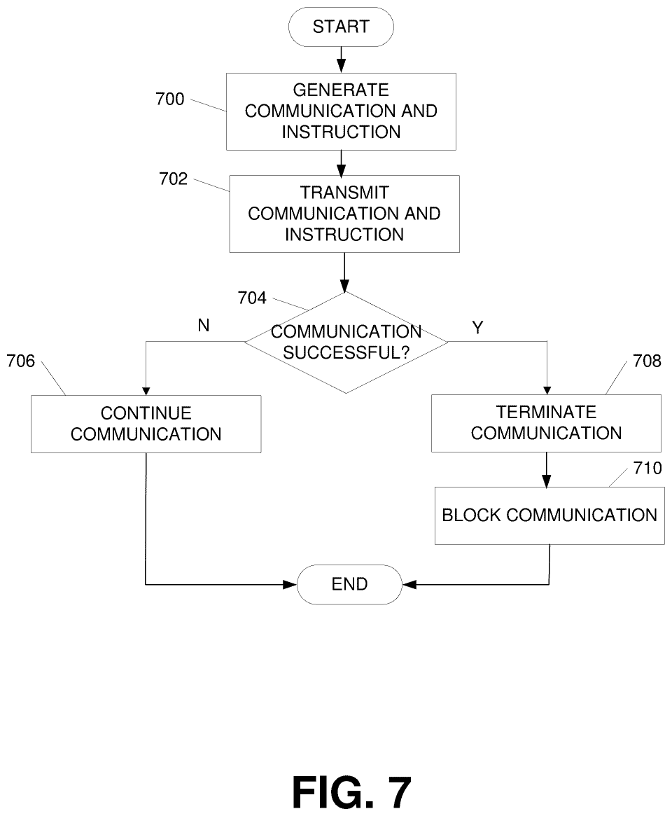

With reference to FIG. 7, still another machine-to-machine multi-factor verification process may include, at step 700, machine-to-machine communication validation computing platform 110 generating a communication and instruction causing the second computing device 130 to request a third computing device 140 (e.g., different from the first computing device 120 and the second computing device 130) to communicate with the first computing device using an initially agreed communication protocol between the first computing device 120 and the second computing device 130.

At step 702, machine-to-machine communication validation computing platform 110 may transmit or send the instruction and communication to the second computing device 130. In some examples, sending the communication and instruction may cause the second computing device 130 to instruct the third computing device 140 to communicate with the first computing device 120 using the initially agreed communication protocol.

At step 704, machine-to-machine communication validation computing platform 110 may monitor the first computing device 120 to determine whether communication between the first computing device 120 and the third computing device 140 is successful. If communication is not successful, at step 706, the first computing device 120 might not be considered compromised and communication between the first computing device 120 and the second computing device 130 may continue (e.g., the pause may be removed).

If, at step 704, the communication between the first computing device 120 and the third computing device 140 is successful, the first computing device 120 may be considered compromised and the paused communication between the first computing device 120 and the second computing device 130 may be terminated at step 708. At step 710, communication between the first computing device 120 and the second computing device 130 may be blocked. In some examples, blocking communication with the first computing device 120 may include blocking communication between the first computing device 120 and the plurality of computing devices (e.g., all computing devices in the system).

Accordingly, aspects described herein ensure secure machine-to-machine data exchange by enabling multi-factor verification of computing devices in a system. For instance, the arrangements described herein provide dynamic methods for validating, in real-time, machine-to-machine communications in order to avoid activities by unauthorized actors, such as spoofing.

Further, while aspects described herein are related to detect a potentially compromised machine and initiating the machine-to-machine multi-factor verification processes, in some examples, the multi-factor verification processes described herein may be used to proactively evaluate machines within a system. For instance, any of the multi-factor verification processes described herein may be used at a predetermined time, at a randomly identified time, or the like to test machines within a system to determine whether any are compromised.

Further, the use of quantum sensors to detect a communication method and a communication protocol being used enables processing of vast amounts of data in real-time or near real-time to detect potentially compromised systems. For instance, the ability to process millions or possibly even billions of transactions is possible through the use of the quantum sensors. The sensors can quickly identify changes in communication between machine or device pairs to identify anomalies that may be further analyzed, either in a live system or in a secure sandbox system.

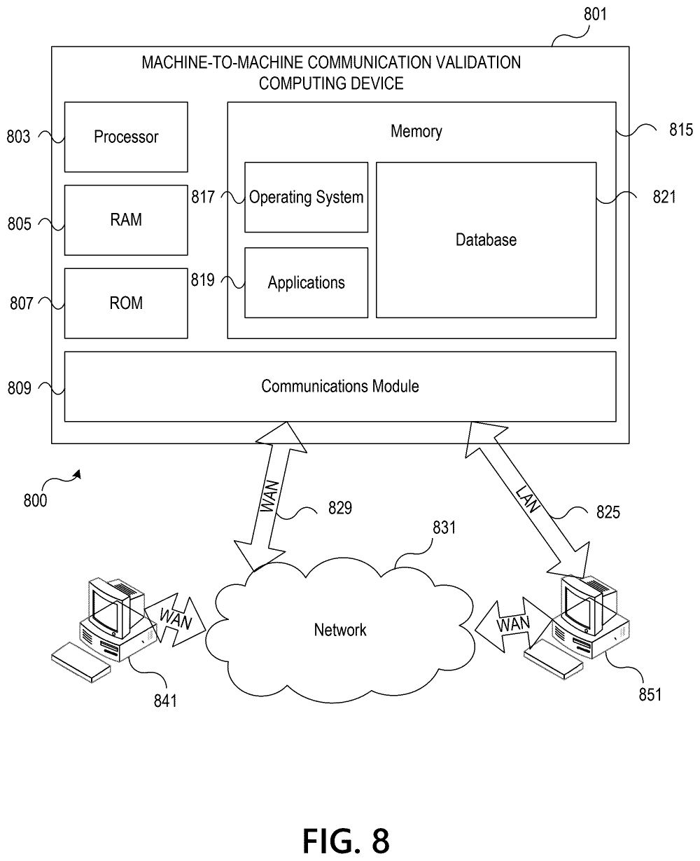

FIG. 8 depicts an illustrative operating environment in which various aspects of the present disclosure may be implemented in accordance with one or more example embodiments. Referring to FIG. 8, computing system environment 800 may be used according to one or more illustrative embodiments. Computing system environment 800 is only one example of a suitable computing environment and is not intended to suggest any limitation as to the scope of use or functionality contained in the disclosure. Computing system environment 800 should not be interpreted as having any dependency or requirement relating to any one or combination of components shown in illustrative computing system environment 800.

Computing system environment 800 may include machine-to-machine communication validation computing device 801 having processor 803 for controlling overall operation of machine-to-machine communication validation computing device 801 and its associated components, including Random Access Memory (RAM) 805, Read-Only Memory (ROM) 807, communications module 809, and memory 815. Machine-to-machine communication validation computing device 801 may include a variety of computer readable media. Computer readable media may be any available media that may be accessed by machine-to-machine communication validation computing device 801, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by machine-to-machine communication validation computing device 801.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on machine-to-machine communication validation computing device 801. Such a processor may execute computer-executable instructions stored on a computer-readable medium.

Software may be stored within memory 815 and/or storage to provide instructions to processor 803 for enabling machine-to-machine communication validation computing device 801 to perform various functions as discussed herein. For example, memory 815 may store software used by machine-to-machine communication validation computing device 801, such as operating system 817, application programs 819, and associated database 821. Also, some or all of the computer executable instructions for machine-to-machine communication validation computing device 801 may be embodied in hardware or firmware. Although not shown, RAM 805 may include one or more applications representing the application data stored in RAM 805 while machine-to-machine communication validation computing device 801 is on and corresponding software applications (e.g., software tasks) are running on machine-to-machine communication validation computing device 801.

Communications module 809 may include a microphone, keypad, touch screen, and/or stylus through which a user of machine-to-machine communication validation computing device 801 may provide input, and may also include one or more of a speaker for providing audio output and a video display device for providing textual, audiovisual and/or graphical output. Computing system environment 800 may also include optical scanners (not shown).

Machine-to-machine communication validation computing device 801 may operate in a networked environment supporting connections to one or more remote computing devices, such as computing devices 841 and 851. Computing devices 841 and 851 may be personal computing devices or servers that include any or all of the elements described above relative to machine-to-machine communication validation computing device 801.

The network connections depicted in FIG. 8 may include Local Area Network (LAN) 825 and Wide Area Network (WAN) 829, as well as other networks. When used in a LAN networking environment, machine-to-machine communication validation computing device 801 may be connected to LAN 825 through a network interface or adapter in communications module 809. When used in a WAN networking environment, machine-to-machine communication validation computing device 801 may include a modem in communications module 809 or other means for establishing communications over WAN 829, such as network 831 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
detect, via one or more quantum sensors, a pattern of communication between a first computing device of a plurality of computing devices and a second computing device of the plurality of computing devices, wherein the pattern of communication includes a communication method and a communication protocol used for communication for each communication interaction between the first computing device and the second computing device;
detect, via the one or more quantum sensors, a first communication interaction between a first computing device of the plurality of computing devices and a second computing device of the plurality of computing devices;
generate, for the first communication interaction between the first computing device and the second computing device, a hash of the first communication interaction, wherein the hash of the first communication interaction is based on a communication method and communication protocol used for communication between the first computing device and the second computing device in the first communication interaction;
store the generated hash of the first communication interaction;
detect, via the one or more quantum sensors, a second communication interaction between the first computing device and the second computing device, wherein the second communication interaction occurs after the first communication interaction;
generate, for the second communication interaction between the first computing device and the second computing device, a hash of the second communication interaction, wherein the hash of the second communication interaction is based on a communication method and communication protocol used for communication between the first computing device and the second computing device in the second communication interaction;
compare the hash of the first communication interaction to the hash of the second communication interaction;
responsive to determining, based on the comparing, that the hash of the first communication interaction matches the hash of the second communication interaction, store the hash of the second communication interaction;
responsive to determining, based on the comparing, that the hash of the first communication interaction does not match the hash of the second communication interaction:
pause communication between the first computing device and the second computing device; and
execute one or more machine-to-machine multi-factor verification processes.

2. The computing platform of claim 1, wherein the communication method used for the communication between the first computing device and the second computing device in the first communication interaction includes one of: radio frequency identification (RFID), near-field communication, or secure machine-to-machine (M2M) communication.

3. The computing platform of claim 1, wherein the communication protocol used for the communication between the first computing device and the second computing device in the first communication interaction includes one of: message queuing telemetry transport (MQTT), constrained application protocol (CoAP), OPC unified architecture (OPC UA), or secure RADIUS.

4. The computing platform of claim 1, wherein executing the one or more machine-to-machine multi-factor verification processes includes:
generating a false fingerprint representing the second computing device;
transmitting the false fingerprint to the first computing device with a request for the first computing device to confirm receipt of the false fingerprint;
receiving, from the first computing device, an indication that the first computing device attempted to initiate communication with the second computing device based on the false fingerprint; and
responsive to receiving the indication that the first computing device attempted to initiate communication with the second computing device based on the false fingerprint, terminating the paused communication between the first computing device and the second computing device and blocking communication between the first computing device and the second computing device.

5. The computing platform of claim 4, wherein blocking the communication from the first computing device to the second computing device further includes blocking communication between the first computing device and the plurality of computing devices.

6. The computing platform of claim 1, wherein executing the one or more machine-to-machine multi-factor verification processes includes:
generating a test message using a communication protocol identified for the first computing device and the second computing device;
transmitting, to the first computing device, the test message using the identified communication method, wherein transmitting the test message includes transmitting a request to confirm receipt of the test message via the identified communication protocol;
monitoring the first computing device to determine whether a confirmation of receipt is sent;
responsive to determining, based on the monitoring, that no confirmation of receipt is sent:
identifying the first computing device as compromised;
terminating the paused communication between the first computing device and the second computing device; and
blocking communication between the first computing device and the second computing device.

7. The computing platform of claim 1, wherein executing the one or more machine-to-machine multi-factor verification processes includes:
generating a quantum encrypted key;
generating an instruction causing the quantum encrypted key to be transmitted to the first computing device using a random communication protocol;
transmitting, to the second computing device, the quantum encrypted key and the instruction, wherein transmitting the quantum encrypted key and instruction causes the second computing device to execute the instruction and send the quantum encrypted key to the first computing device using the random communication protocol;
monitoring the plurality of devices for a response including the quantum encrypted key;
detecting, based on the monitoring, the response including the quantum encrypted key from a device other than the first computing device; and
responsive to detecting the response including the quantum encrypted key from the device other than the first computing device:
identifying the first computing device as compromised;
terminating the paused communication between the first computing device and the second computing device; and
blocking communication between the first computing device and the second computing device.

8. The computing platform of claim 1, wherein executing the one or more machine-to-machine multi-factor verification processes includes:
generating a communication and instruction causing the second computing device to request a third computing device to communicate with the first computing device using an initially agreed communication protocol between the first computing device and the second computing device;
transmitting, to the second computing device, the communication and instruction, wherein transmitting the communication and instruction causes the second computing device to instruct the third computing device to communicate with the first computing device using the initially agreed communication protocol;
monitoring the first computing device to determine whether communication between the first computing device and the third computing device is successful;
responsive to determining that the communication between the first computing device and the third computing device is successful:
identifying the first computing device as compromised;
terminating the paused communication between the first computing device and the second computing device; and
blocking communication between the first computing device and the second computing device.

9. The computing platform of claim 1, wherein the hash of the first communication interaction is further based on an identifier of the first computing device and an identifier of the second computing device.

10. A method, comprising:
detecting, by a computing platform, the computing platform having at least one processor, and memory, via one or more quantum sensors, a pattern of communication between a first computing device of a plurality of computing devices and a second computing device of the plurality of computing devices, wherein the pattern of communication includes a communication method and a communication protocol used for communication for each communication interaction between the first computing device and the second computing device;
detecting, by the at least one processor and via the one or more quantum sensors, a first communication interaction between a first computing device of the plurality of computing devices and a second computing device of the plurality of computing devices;
generate, by the at least one processor and for the first communication interaction between the first computing device and the second computing device, a hash of the first communication interaction, wherein the hash of the first communication interaction is based on a communication method and communication protocol used for communication between the first computing device and the second computing device in the first communication interaction;
storing, by the at least one processor, the generated hash of the first communication interaction;
detecting, by the at least one processor and via the one or more quantum sensors, a second communication interaction between the first computing device and the second computing device, wherein the second communication interaction occurs after the first communication interaction;
generating, by the at least one processor and for the second communication interaction between the first computing device and the second computing device, a hash of the second communication interaction, wherein the hash of the second communication interaction is based on a communication method and communication protocol used for communication between the first computing device and the second computing device in the second communication interaction;
comparing, by the at least one processor, the hash of the first communication interaction to the hash of the second communication interaction;
responsive to determining, based on the comparing, that the hash of the first communication interaction matches the hash of the second communication interaction, storing, by the at least one processor, the hash of the second communication interaction;
responsive to determining, based on the comparing, that the hash of the first communication interaction does not match the hash of the second communication interaction:
pausing, by the at least one processor, communication between the first computing device and the second computing device; and
executing, by the at least one processor, one or more machine-to-machine multi-factor verification processes.

11. The method of claim 10, wherein executing the one or more machine-to-machine multi-factor verification processes includes:
generating, by the at least one processor, a false fingerprint representing the second computing device;
transmitting, by the at least one processor, the false fingerprint to the first computing device with a request for the first computing device to confirm receipt of the false fingerprint;
receiving, by the at least one processor and from the first computing device, an indication that the first computing device attempted to initiate communication with the second computing device based on the false fingerprint; and
responsive to receiving the indication that the first computing device attempted to initiate communication with the second computing device based on the false fingerprint, terminating, by the at least one processor, the paused communication between the first computing device and the second computing device and blocking communication between the first computing device and the second computing device.

12. The method of claim 10, wherein executing the one or more machine-to-machine multi-factor verification processes includes:
generating, by the at least one processor, a test message using a communication protocol identified for the first computing device and the second computing device;
transmitting, by the at least one processor and to the first computing device, the test message using the identified communication method, wherein transmitting the test message includes transmitting a request to confirm receipt of the test message via the identified communication protocol;
monitoring, by the at least one processor, the first computing device to determine whether a confirmation of receipt is sent;
responsive to determining, based on the monitoring, that no confirmation of receipt is sent:
identifying, by the at least one processor, the first computing device as compromised;
terminating, by the at least one processor, the paused communication between the first computing device and the second computing device; and
blocking, by the at least one processor, communication between the first computing device and the second computing device.

13. The method of claim 10, wherein executing the one or more machine-to-machine multi-factor verification processes includes:
generating, by the at least one processor, a quantum encrypted key;
generating, by the at least one processor, an instruction causing the quantum encrypted key to be transmitted to the first computing device using a random communication protocol;
transmitting, by the at least one processor and to the second computing device, the quantum encrypted key and the instruction, wherein transmitting the quantum encrypted key and instruction causes the second computing device to execute the instruction and send the quantum encrypted key to the first computing device using the random communication protocol;
monitoring, by the at least one processor, the plurality of devices for a response including the quantum encrypted key;
detecting, by the at least one processor and based on the monitoring, the response including the quantum encrypted key from a device other than the first computing device; and
responsive to detecting the response including the quantum encrypted key from the device other than the first computing device:
identifying, by the at least one processor, the first computing device as compromised;
terminating, by the at least one processor, the paused communication between the first computing device and the second computing device; and
blocking, by the at least one processor, communication between the first computing device and the second computing device.

14. The method of claim 10, wherein executing the one or more machine-to-machine multi-factor verification processes includes:
generating, by the at least one processor, a communication and instruction causing the second computing device to request a third computing device to communicate with the first computing device using an initially agreed communication protocol between the first computing device and the second computing device;
transmitting, by the at least one processor and to the second computing device, the communication and instruction, wherein transmitting the communication and instruction causes the second computing device to instruct the third computing device to communicate with the first computing device using the initially agreed communication protocol;
monitoring, by the at least one processor, the first computing device to determine whether communication between the first computing device and the third computing device is successful;
responsive to determining that the communication between the first computing device and the third computing device is successful:
identifying, by the at least one processor, the first computing device as compromised;
terminating, by the at least one processor, the paused communication between the first computing device and the second computing device; and
blocking, by the at least one processor, communication between the first computing device and the second computing device.

15. The method of claim 10, wherein the hash of the first communication interaction is further based on an identifier of the first computing device and an identifier of the second computing device.

16. One or more non-transitory computer-readable media storing instructions that, when executed by a computing platform comprising at least one processor, memory, and a communication interface, cause the computing platform to:
detect, via one or more quantum sensors, a pattern of communication between a first computing device of a plurality of computing devices and a second computing device of the plurality of computing devices, wherein the pattern of communication includes a communication method and a communication protocol used for communication for each communication interaction between the first computing device and the second computing device;
detect, via the one or more quantum sensors, a first communication interaction between a first computing device of the plurality of computing devices and a second computing device of the plurality of computing devices;
generate, for the first communication interaction between the first computing device and the second computing device, a hash of the first communication interaction, wherein the hash of the first communication interaction is based on a communication method and communication protocol used for communication between the first computing device and the second computing device in the first communication interaction;
store the generated hash of the first communication interaction;
detect, via the one or more quantum sensors, a second communication interaction between the first computing device and the second computing device, wherein the second communication interaction occurs after the first communication interaction;
generate, for the second communication interaction between the first computing device and the second computing device, a hash of the second communication interaction, wherein the hash of the second communication interaction is based on a communication method and communication protocol used for communication between the first computing device and the second computing device in the second communication interaction;
compare the hash of the first communication interaction to the hash of the second communication interaction;
responsive to determining, based on the comparing, that the hash of the first communication interaction matches the hash of the second communication interaction, store the hash of the second communication interaction;
responsive to determining, based on the comparing, that the hash of the first communication interaction does not match the hash of the second communication interaction:
pause communication between the first computing device and the second computing device; and
execute one or more machine-to-machine multi-factor verification processes.

17. The one or more non-transitory computer-readable media of claim 16, wherein executing the one or more machine-to-machine multi-factor verification processes includes:
generating a false fingerprint representing the second computing device;
transmitting the false fingerprint to the first computing device with a request for the first computing device to confirm receipt of the false fingerprint;
receiving, from the first computing device, an indication that the first computing device attempted to initiate communication with the second computing device based on the false fingerprint; and
responsive to receiving the indication that the first computing device attempted to initiate communication with the second computing device based on the false fingerprint, terminating the paused communication between the first computing device and the second computing device and blocking communication between the first computing device and the second computing device.

18. The one or more non-transitory computer-readable media of claim 16, wherein executing the one or more machine-to-machine multi-factor verification processes includes:
generating a test message using a communication protocol identified for the first computing device and the second computing device;
transmitting, to the first computing device, the test message using the identified communication method, wherein transmitting the test message includes transmitting a request to confirm receipt of the test message via the identified communication protocol;
monitoring the first computing device to determine whether a confirmation of receipt is sent;
responsive to determining, based on the monitoring, that no confirmation of receipt is sent:
identifying the first computing device as compromised;
terminating the paused communication between the first computing device and the second computing device; and
blocking communication between the first computing device and the second computing device.

19. The one or more non-transitory computer-readable media of claim 16, wherein executing the one or more machine-to-machine multi-factor verification processes includes:
generating a quantum encrypted key;
generating an instruction causing the encrypted key to be transmitted to the first computing device using a random communication protocol;
transmitting, to the second computing device, the quantum encrypted key and the instruction, wherein transmitting the quantum encrypted key and instruction causes the second computing device to execute the instruction and send the quantum encrypted key to the first computing device using the random communication protocol;
monitoring the plurality of devices for a response including the quantum encrypted key;
detecting, based on the monitoring, the response including the quantum encrypted key from a device other than the first computing device; and
responsive to detecting the response including the quantum encrypted key from the device other than the first computing device:
identifying the first computing device as compromised;
terminating the paused communication between the first computing device and the second computing device; and
blocking communication between the first computing device and the second computing device.

20. The one or more non-transitory computer-readable media of claim 16, wherein executing the one or more machine-to-machine multi-factor verification processes includes:
generating a communication and instruction causing the second computing device to request a third computing device to communicate with the first computing device using an initially agreed communication protocol between the first computing device and the second computing device;
transmitting, to the second computing device, the communication and instruction, wherein transmitting the communication and instruction causes the second computing device to instruct the third computing device to communicate with the first computing device using the initially agreed communication protocol;
monitoring the first computing device to determine whether communication between the first computing device and the third computing device is successful;
responsive to determining that the communication between the first computing device and the third computing device is successful:
identifying the first computing device as compromised;
terminating the paused communication between the first computing device and the second computing device; and
blocking communication between the first computing device and the second computing device.
